(19) United States
(12) Patent Application Publication
(10) Pub. No.: US 2007/0211489 A1
(43) Pub. Date: Sep. 13, 2007

(54) LIGHT-PIPES AND ELECTRONIC DEVICES UTILIZING THE SAME

(75) Inventors: JIUNN-HER LI, Tu-Cheng (TW); SHIH-CHANG HSU, Tu-Cheng (TW); WEI-HSI CHEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/611,141

(22) Filed: Dec. 15, 2006

(30) Foreign Application Priority Data
Mar. 10, 2006 (TW) 95108174

(51) Int. Cl. F21V 7/04

(52) U.S. Cl. 362/551

(57) ABSTRACT

A light-pipe (50) includes a first portion (52) for collecting light from a light source (93), and a second portion (54) for transferring the light from the first portion and outputting the light. The second portion is disposed opposite to the first portion. The first portion includes a plurality of protrusions (521) disposed thereon. The light-pipe defines a keyhole (56) extending through the first portion and the second portion.

### BACKGROUND OF THE INVENTION

1. Field of the Invention

The present invention pertains to a light-pipe, and particularly to an electronic device utilizing the light pipe.

2. Description of Related Art

Light-pipes are used in numerous applications to transfer light from one location to another. For example, light-pipes are often used to transfer light from a light source such as a light emitting diode (LED) located within a housing to an exterior of the housing to illuminate corresponding keys for facilitating nighttime use.

A typical light-pipe includes an input end disposed adjacent to the light source for collecting light from the light source. The collected light is transferred through the light-pipe and is output at an output end of the light-pipe. However, the input end greatly reflects the light, thus causing a loss of illuminating power between the light source and the input end, and resulting in decreased intensity at the output end of the light-pipe. Therefore, the intensity of the light at the output end of the light-pipe for nighttime use is often less than desirable.

Therefore, a heretofore unaddressed need exists in the industry to overcome the aforementioned deficiencies and inadequacies.

### SUMMARY OF THE INVENTION

In an exemplary embodiment, a light-pipe includes a first portion for collecting light from a light source, and a second portion for transferring the light from the first portion and outputting the light. The second portion is disposed opposite to the first portion. The first portion includes a plurality of protrusions disposed thereon. The light-pipe defines a keyhole extending through the first portion and the second portion.

In another exemplary embodiment, an electronic device includes a circuit board, at least one light-pipe, at least one key, and a panel. The circuit board including at least one switch and a plurality of light sources disposed thereon. The light-pipe includes a first portion for collecting light from the light source, and a second portion for transferring the light from the first portion and outputting the light. The second portion is disposed opposite to the first portion. The first portion includes a plurality of protrusions disposed thereon. The key includes a key body. The panel includes a receiving hole for receiving the second portion. The light-pipe defines a keyhole for receiving the key body. The keyhole extends through the first portion and the second portion.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, isometric view of an electronic device of an exemplary embodiment of the present invention, the electronic device including a light-pipe, a key, a panel, and a circuit board;

FIG. 2 is an enlarged, isometric view of the light-pipe of the electronic device of FIG. 1;

FIG. 3 is similar to FIG. 2, but viewed from another aspect;

FIG. 4 is an enlarged, isometric view of the key of the electronic device of FIG. 1

FIG. 5 is an enlarged, inverted, isometric view of the key of FIG. 4;

FIG. 6 is an enlarged, isometric view of the panel of the electronic device of FIG. 1;

FIG. 7 is an enlarged view of a circled portion VII of FIG. 1;

FIG. 8 is an assembled view of FIG. 1; and

FIG. 9 is a schematic diagram of light reflecting in the light-pipe of FIG. 2.

### DETAILED DESCRIPTION OF THE INVENTION

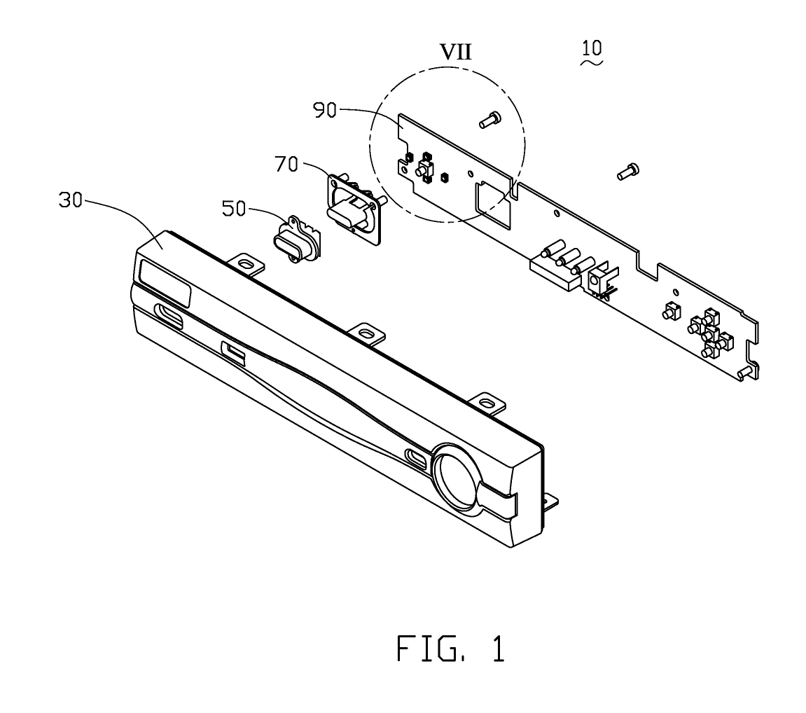

Referring to FIG. 1, an electronic device 10 of an exemplary embodiment of the present invention comprises a panel 30, a light-pipe 50, a key 70, and a circuit board 90. Note that the light-pipe 50 can be a stand-alone product or a part of another electronic device.

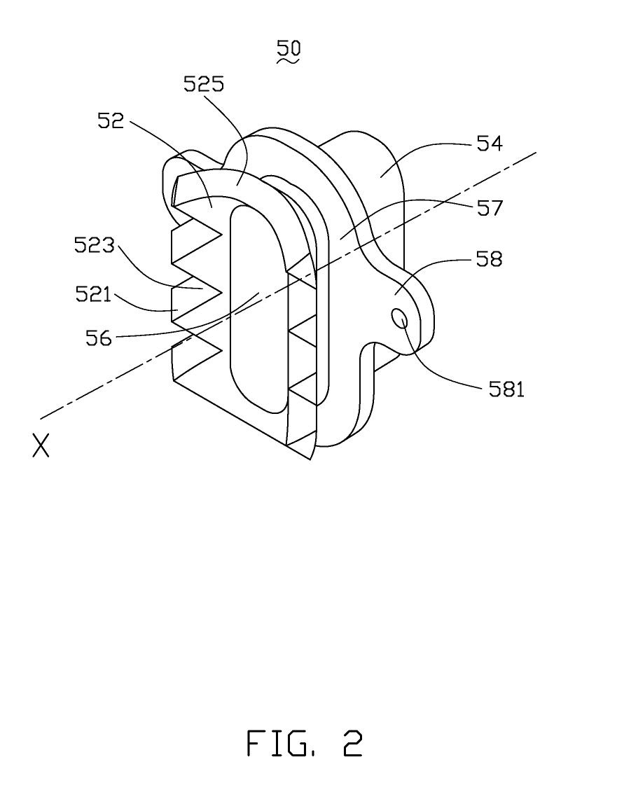

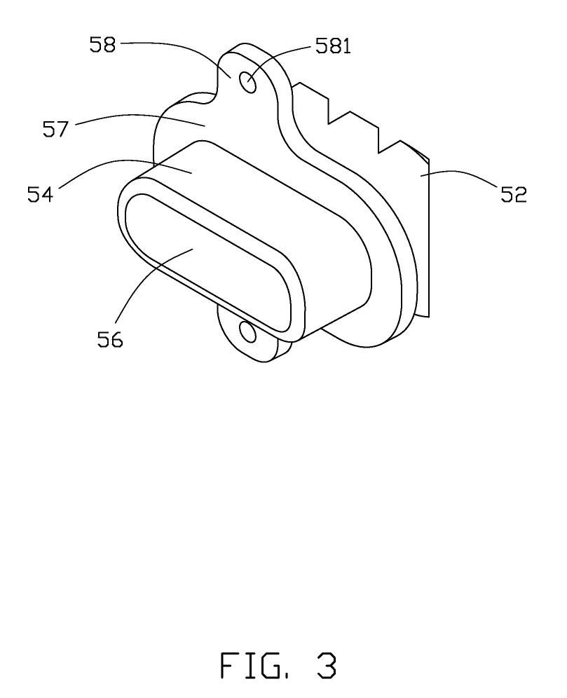

Referring to FIGS. 2 and 3, The light-pipe 50 comprises a first portion 52 for collecting light, a second portion 54 for outputting the light, a flange 57 disposed between the first portion 52 and the second portion 54, and a pair of side portions 58 extending from opposite sides of the flange 57. The second portion 54 is opposite to the first portion 52. The first portion 52 comprises a plurality of protrusions 521 arranged in double rows and disposed on a distal end thereof, and a pair of curved connecting portions 525 for connecting the double rows of protrusions 521. The protrusions 521 are sawtooth-shaped, and every two adjacent sawtooth-shaped protrusions 521 define a V-shaped groove 523 therebetween. Therefore, an uneven surface to face light sources 93 (as mentioned below) can be formed and defined by the protrusions 521 and the curved connecting portions 525 respectively. The flange 57 is shaped as a ring. Each side portion 58 defines a fixing hole 581 therein. The light-pipe 50 defines a keyhole 56 extending through the first portion 52 to the second portion 54. In another exemplary embodiment, the protrusions 521 can be ∩-shaped, and between every two adjacent ∩-shaped protrusions 521, a ∪-shaped groove 523 is defined.

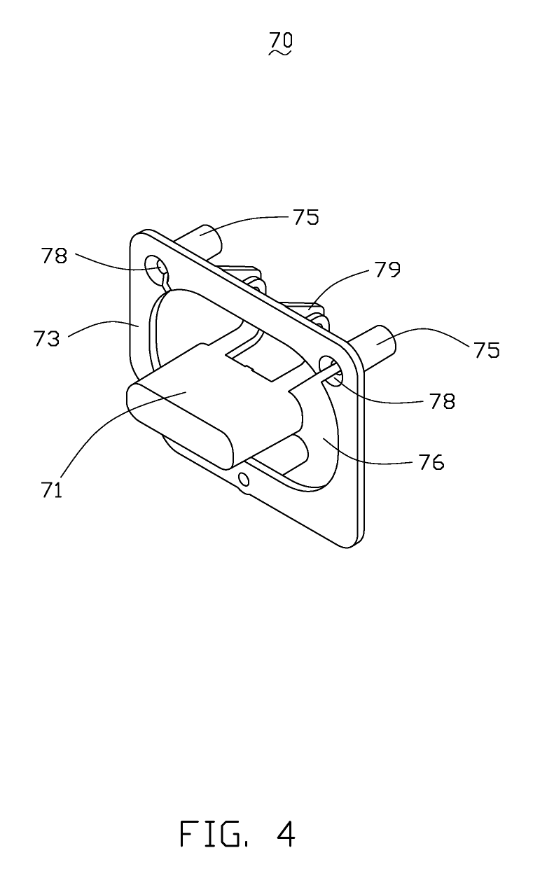

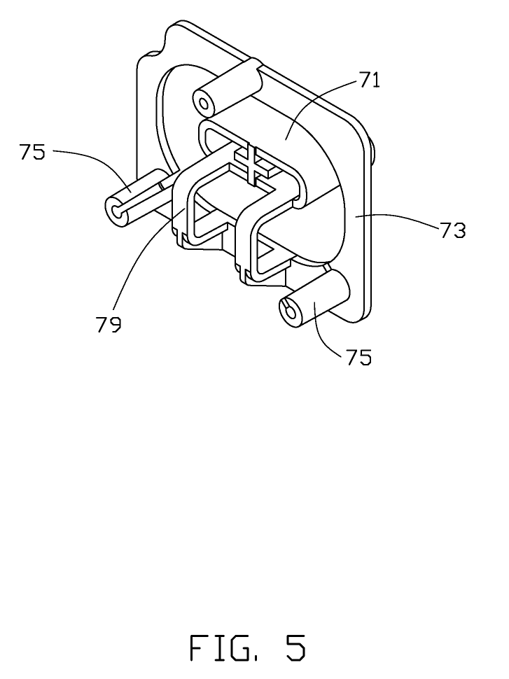

Referring to FIGS. 4 and 5, the key 70 comprises a key body 71, a key base 73, a pair of columns 75 projecting from the key base 73, and a pair of connecting members 79. The key body 71 is located at one side of the key base 73. The columns 75 are located at another side of the key base 73. The key base 73 defines an opening 76 substantially in the middle thereof. The connecting members 79 go through the opening 76 and connect the key base 73 with the key body 71. Each column 75 defines a through-hole 78 extending therethrough.

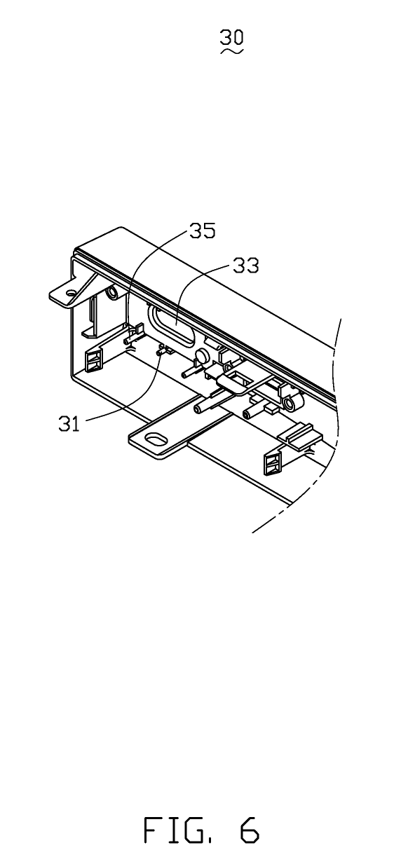

Referring to FIG. 6, the panel 30 comprises a receiving hole 33 for receiving the key body 71, a pair of first fixing pins 31 corresponding to the respective fixing hole 581, and a pair of second fixing pins 35 corresponding to the through-holes 78. The first fixing pins 31 are disposed on two opposite edges of the receiving hole 33. The second fixing pins 35 are arranged and disposed on an edge of the receiving hole 33.

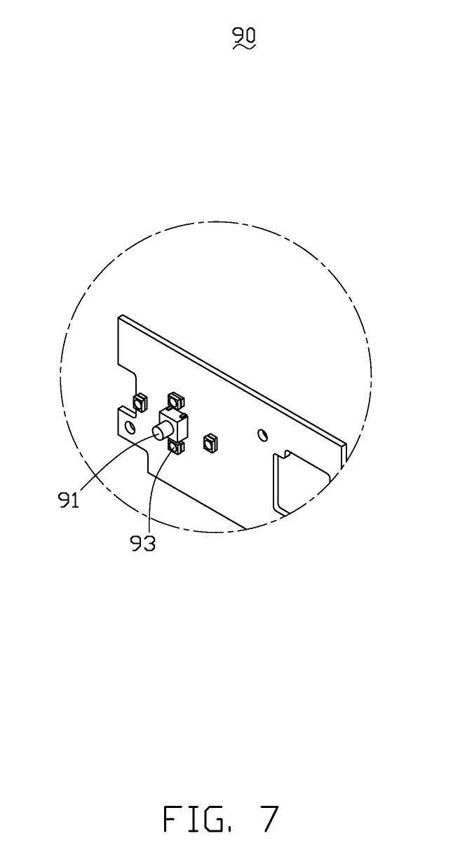

Referring to FIG. 7, the circuit board 90 comprises an electronic component like a switch 91 corresponding to the key body 71 of the key 70, and a plurality of light sources 93 such as light emitting diodes (LEDs). The light sources 93 are disposed around the switch 91. In the exemplary embodiment, the number of light sources 93 is four.

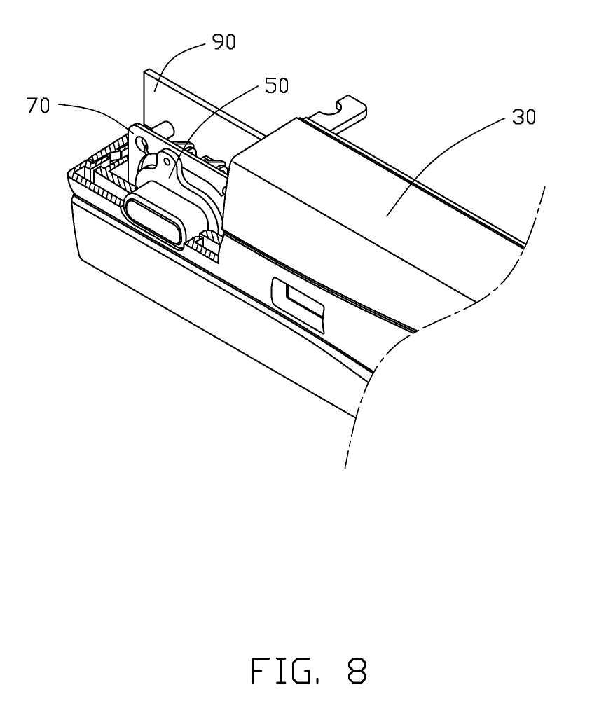

Referring to FIG. 8, In assembly, the second portion 54 of the light-pipe 50 is received in the receiving hole 33 of the panel 30. Each first fixing pin 31 is received in the corresponding fixing hole 581, and is fixed to the light-pipe 50 by heat-forming technology. The flange 57 of the light-pipe 50 abuts against an inner surface of the panel 30. The key body 71 is received in the keyhole 56 of the light-pipe 50. The key base 73 abuts against the flange 57 of the light-pipe 50. Each second fixing pin 33 is received in the corresponding through-hole 79 of the key 70. The circuit board 90 is mounted to the panel 30 through the use of at least one screw. The switch 91 abuts against the key body 71, thus the force acted on the key 70 can be transferred to the switch 91 to operate the switch 91.

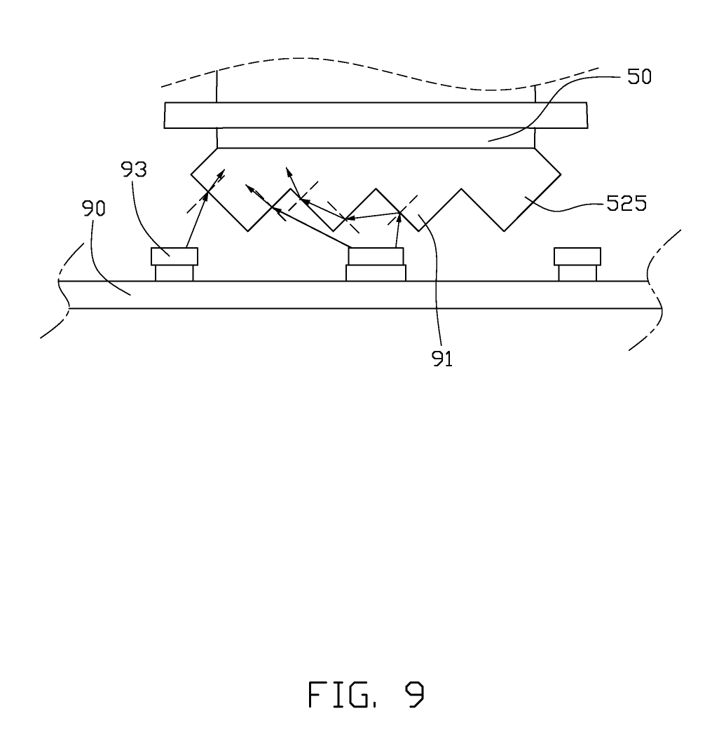

Referring to FIG. 9, it illustrates a schematic diagram of light entering into the light-pipe 50. During use, the light from the light sources 93 is reflected several times on surfaces of the protrusions 521, and then the light is introduced into the light-pipe 50, thus the introduced light transfers to the second portion 54 at several different angles, and the loss of the light is reduced. Therefore, the brightness of the light transferred to the second portion 54 is uniform, thus forming a uniform light-ring, and obtaining a desirable intensity of the light to facilitate nighttime use.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A light-pipe, comprising:
a first portion of the light-pipe for collecting light from a light source, the first portion comprising a plurality of protrusions disposed thereon; and
a second portion of the light-pipe for outputting the light, the second portion being disposed opposite to the first portion;
wherein the light-pipe defines a keyhole at a middle of the light-pipe extending through the first portion and the second portion.

2. The light-pipe as claimed in claim 1, further comprising a flange disposed between the first portion and the second portion.

3. The light-pipe as claimed in claim 2, wherein the flange is shaped as a ring.

4. The light-pipe as claimed in claim 2, further comprising a pair of side portions extending from opposite sides of the flange.

5. The light-pipe as claimed in claim 4, wherein each side portion defines a fixing hole therein.

6. The light-pipe as claimed in claim 1, wherein the protrusions are arranged in double rows.

7. The light-pipe as claimed in claim 6, wherein the first portion further comprising a pair of connecting portions for connecting the double rows of protrusions.

8. The light-pipe as claimed in claim 1, wherein the protrusions are sawtooth-shaped, and every two adjacent sawtooth-shaped protrusions define a V-shaped groove.

9. The light-pipe as claimed in claim 1, wherein the protrusions are ∩-shaped, and every two adjacent protrusions define a ∪-shaped groove.

10. An electronic device, comprising:
a circuit board comprising at least one switch and a plurality of light sources disposed thereon;
at least one light-pipe, comprising:
a first portion of the at least one light-pipe for collecting light from the light sources, the first portion comprising a plurality of protrusions disposed thereon; and
a second portion of the at least one light-pipe for outputting the light, the second portion being disposed opposite to the first portion;
at least one key comprising a key body; and
a panel comprising a receiving hole for receiving the second portion;
wherein the light-pipe defines a keyhole for receiving the key body, the keyhole extending through the first portion and the second portion.

11. The electronic device as claimed in claim 10, further comprising a flange disposed between the first portion and the second portion.

12. The electronic device as claimed in claim 11, further comprising a pair of side portions extending from opposite sides of the flange.

13. The electronic device as claimed in claim 12, wherein each side portion defines a fixing hole therein.

14. The electronic device as claimed in claim 13, wherein the panel further comprises a pair of first fixing pins disposed on two opposite edges of the receiving hole, and a pair of second fixing pins arranged and disposed on an edge of the receiving hole, each first fixing pin being received in the corresponding fixing hole.

15. The electronic device as claimed in claim 14, wherein the key further comprises a key base, at least one connecting member for connecting the key base to the key body, and a pair of columns defining a through-hole for receiving the respective second fixing pins.

16. The electronic device as claimed in claim 10, wherein the protrusions are arranged in double rows.

17. The electronic device as claimed in claim 16, wherein the first portion further comprising a pair of connecting portions for connecting the double rows of protrusions.

18. The electronic device as claimed in claim 10, wherein the protrusion is sawtooth-shaped, and each two adjacent sawtooth-shaped protrusions define a V-shaped groove.

19. An electronic device, comprising:
a panel extending along a side of said electronic device for shielding said electronic device at said side thereof;
an electronic component disposed in said electronic device and spaced from said panel;
more than one light source disposed in said electronic device and neighboring said electronic component;
a key correspondingly disposed between said panel and said electronic component, said key being accessible at said panel from an outside of said electronic device and movable toward said electronic component to activate said electronic component for functioning; and
a light-pipe extending between said more than one light source and said panel and extending to surround said key, said light-pipe being viewable at said panel and able to receive light from said more than one light source and transmit said light to said panel for viewing, at least one uneven surface defined to face each of said more than one light source for better light receiving of said light-pipe.

20. The electronic device as claimed in claim 19, wherein said uneven surface is defined by a selective one of a row of protrusions and a curved connecting portion respectively formed at a distal end of said light-pipe.
